(19) United States
(12) Patent Application Publication
(10) Pub. No.: US 2012/0138181 A1
(43) Pub. Date: Jun. 7, 2012

(54) Multiple valve fluid manifold and line splitter assembly

(76) Inventors: Steve C. Smith, Trabuco Canyon, CA (US); Bruce H. Menk, Costa Mesa, CA (US)

(21) Appl. No.: 12/928,137

(22) Filed: Dec. 2, 2010

(51) Int. Cl. G05D 7/00; B05B 15/02

(52) U.S. Cl. 137/884; 137/861; 137/885; 239/112

(57) ABSTRACT

A multiple valve fluid manifold and line splitter assembly includes a flush valve mounted on two or more spool valves with flush-faced seal glands mounted on a common manifold block. When one or more paint line valves close, the manifold block continues to supply the open paint line valve circuits with paint. The closed paint line valve can then be completely flushed without unflushed residuals remaining in dead spots, cavities or pockets of the spool valve. The complete manifold valve assembly can be flushed out by flushing solvent through the inlet port of the manifold block and out through the open line valve circuits of the system.

### FIELD OF THE INVENTION

This invention relates generally to apparatus for spray painting and other environments in which a liquid is sprayed under pressure and relates more particularly to multiple spray gun painting systems which apply paints and which require line, valve and spray gun flushing with solvents to remove paint following use.

### BACKGROUND OF THE INVENTION

In many commercial production spray painting operations, a plurality of spray booths are fed paint under pressure from one or more central pumping stations. Typically, each spray booth provides a plurality of individual spray guns. Thus, during full capacity operations, multiple spray gun operators are on-line and engaged in painting within multiple spray booths all utilizing a common pressurized supply of paint. The paint under pressure is fed through a plurality of feed lines forming a paint distribution network. During less than full capacity operations, it may be desirable or even necessary to take one or more spray booths or individual spray gun operators within a given spray booth off-line while others remain on-line and fully operative. The chemical nature of most modern paints which harden or cure in response to chemical processes within the paints give rise to the undesirable possibility that paint within lines and other components of the distribution system such as valves or spray guns may cure or harden during periods of nonuse. To avoid the undesired contamination of paint lines, valves and spray guns caused by residual hardened paint within the system, the entire system feeding a spray gun must be flushed and cleaned with solvents when taken off-line. This flushing or cleaning must be extremely thorough and must include each area and line portion within the system to avoid leaving contaminating residual deposits which may degrade subsequent painting operations when the line is restored to use. In large multiple booth, multiple spray gun operations, this cleaning requirement typically leads to taking a number of spray guns off-line solely to facilitate shut down of a single spray gun or partial number of the total spray guns within the system. The interruption of work by some spray gun operators to accommodate shutdown and cleaning of other spray guns in the system negatively impacts cost effectiveness and efficiency of the entire painting operation. In many instances, entire paint lines, valves and multiple spray guns are unnecessarily shutdown, cleaned and put back on-line to implement a partial off-line of some spray guns that share the effected lines and valves.

The loss of time and inefficiency of partial shutdowns within a painting operation may be substantial. Further, many modern paints are extremely expensive to the extent that wasting even small amounts of paints due to cleaning and flushing of common lines and valves shared by spray guns being taken off-line and spray guns which are to remain on-line dramatically increases operation costs.

Faced with the financial impact of partial shutdown within painting operation, practitioners in the art often endeavor to use multiple valves for multiple paint lines to isolate spray guns from each other and thereby reduce waste and losses. While these measure have enjoyed some success, there remains nonetheless a need in the art for low cost, effective spray painting apparatus which facilitate manual or automate on/off-line flushing of multiple lines without leaving unflushed “dead spots”, cavities or pockets of residual paint and further facilitating off-lining of one or more spray guns while maintaining on-line operation of the remaining spray guns within the system.

### SUMMARY OF THE INVENTION

Accordingly, it is a general object of the present invention to provide an improved multiple user apparatus for fluid distribution within a fluid spray system. It is a more particular object of the present invention to provide an improved multi-valve fluid manifold and line splitter assembly for use in multiple user operations such as spray painting or material application which facilitates complete flushing and cleaning of portions of the system while maintaining the remainder of the system on-line and in full operation. The inventive system may be used with manual spray or material application systems or with automated robotic systems.

In accordance with the present invention, there is provided a multiple valve fluid manifold and line splitter comprising: a manifold having a manifold chamber, a material input coupled to the manifold chamber and first and second material outputs coupled to the manifold chamber; a first line splitter valve, coupled to the first material output, defining an open condition flowing material from the first material output and a closed condition preventing material flow from the first material output, and having a first solvent input; a second line splitter valve, coupled to the second material output, defining an open condition flowing material from the second material output and a closed condition preventing material flow from the second material output, and having a second solvent input; and solvent valve means coupled to the first and second solvent inputs for flushing solvent through the first and second line splitter valves, together or individually.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a multiple user paint spray facility constructed in accordance with the present invention;

FIG. 2 sets forth a top view of multiple valve fluid manifold and line splitter assembly constructed in accordance with the present invention; and

FIG. 3 sets forth a partially section top view of a multiple valve fluid manifold and line splitter assembly constructed in accordance with the present invention and coupled to sources of paint and cleaning solvent.

### DESCRIPTION OF THE PREFERRED EMBODIMENT OF THE INVENTION

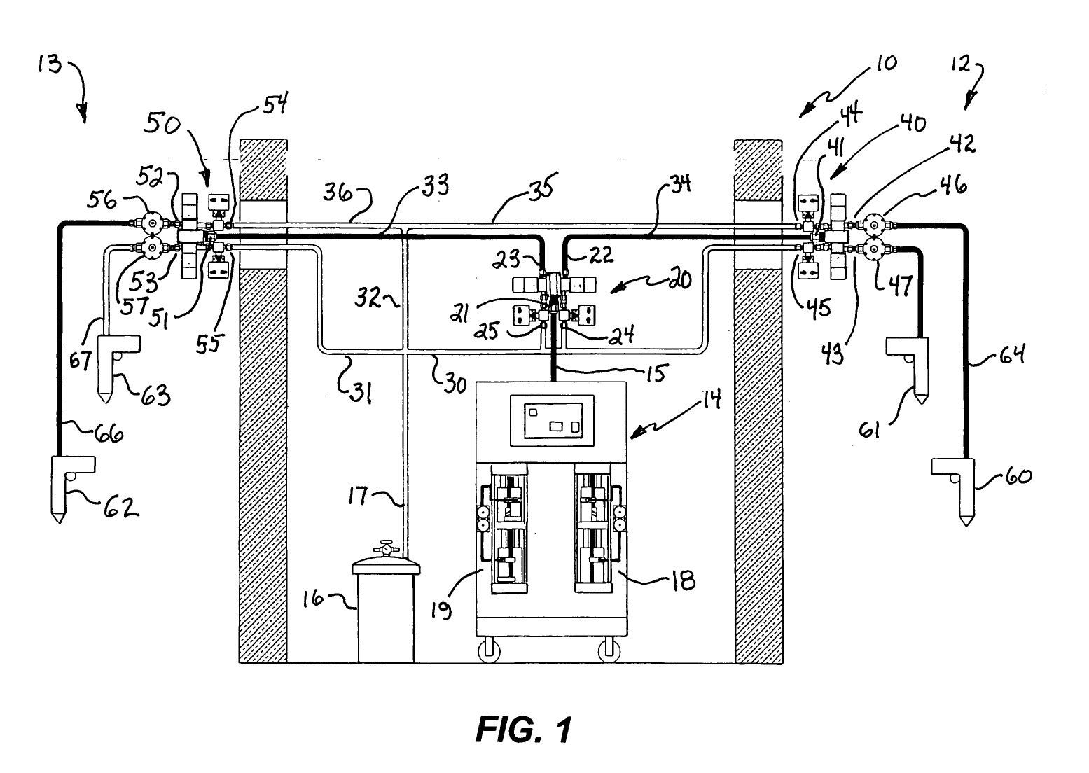

FIG. 1 sets forth a layout diagram of a commercial multiple spray gun multiple spray booth painting operation constructed in accordance with the present invention and generally referenced by numeral 10. For purposes of illustration, painting system 10 is shown using paint spray guns operated manually. It should be noted that robotic systems may also be driven by the inventive system. Further, other material applicators may be used instead of spray guns.

Painting system 10 is shown having a central supply area 11 together with a pair of spray booths 12 and 13 separated therefrom by partitioning walls. By way of overview, it will be apparent to those skilled in the art that while FIG. 1 shows the present invention implemented in a painting system while utilizes two separate spray booths operated by a central supply area and that each spray booth in turn supports a pair of spray guns, other combination of spray guns and spray booths operated by a common central supply area can be utilized without departing from the spirit and scope of the present invention. For example, the present invention may be utilized in systems in which a large number of spray guns are operating from a common supply system. Conversely, the present invention system is equally applicable to facilities in which a large number of spray booths are utilized having single spray guns in operation for each booth. A variety of combination of spray booths and spray guns may be utilized while receiving the benefits of the present invention system. Simply stated, the present invention system facilitates the isolation and shutdown of a portion of a painting system and/or one or more selected spray guns within the system portions to be taken off/line without disturbing or interrupting the continuing operation of those portions of the system which remain on-line. Of particular importance in the present invention is the ability to completely flush solvent and cleaner through selected portions of the system for complete cleaning and avoidance of residual material remaining within the system.

It will also be apparent to those skilled in the art that while the descriptive material which follows in conjunction with FIGS. 1 through 3 describes an embodiment of present invention utilized in spraying paint, the present invention system applies equally well to a variety of sprayable materials such as protective coatings, preservatives or other spray applied materials. In addition, it will be apparent that the present invention system maybe used for the application of single and plural component adhesives both sprayable or non-sprayable. The inventive system may also be used with food products or any compound from a liquid to non-flowable pastes either with or without solids content.

It will be further apparent to those skilled in the art that while the embodiment shown in FIG. 1 utilizes spray guns 60 through 63, other material transfer devices such as caulking guns or applicators may be used without departing from the spirit and scope of the present invention.

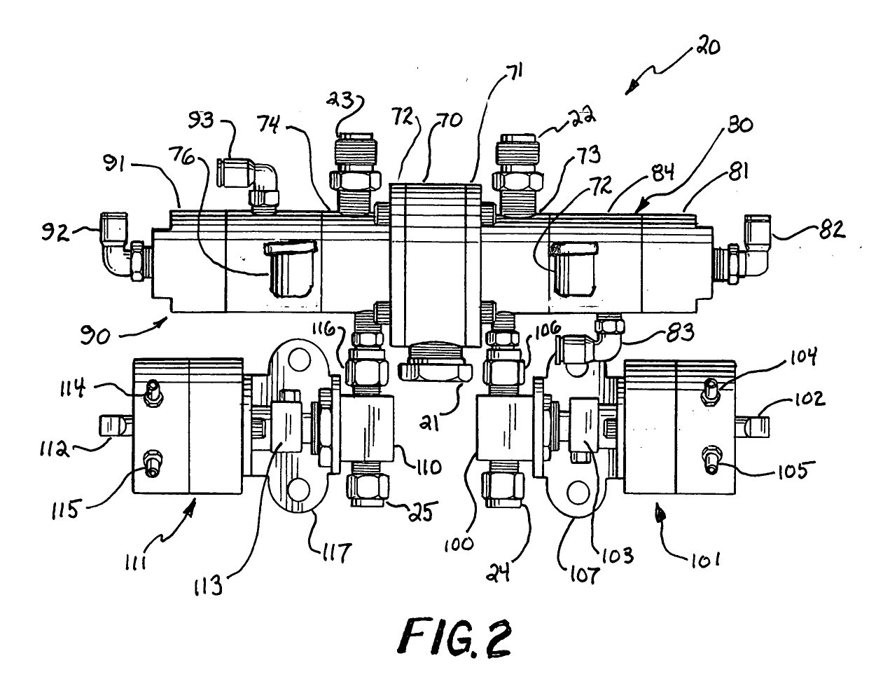

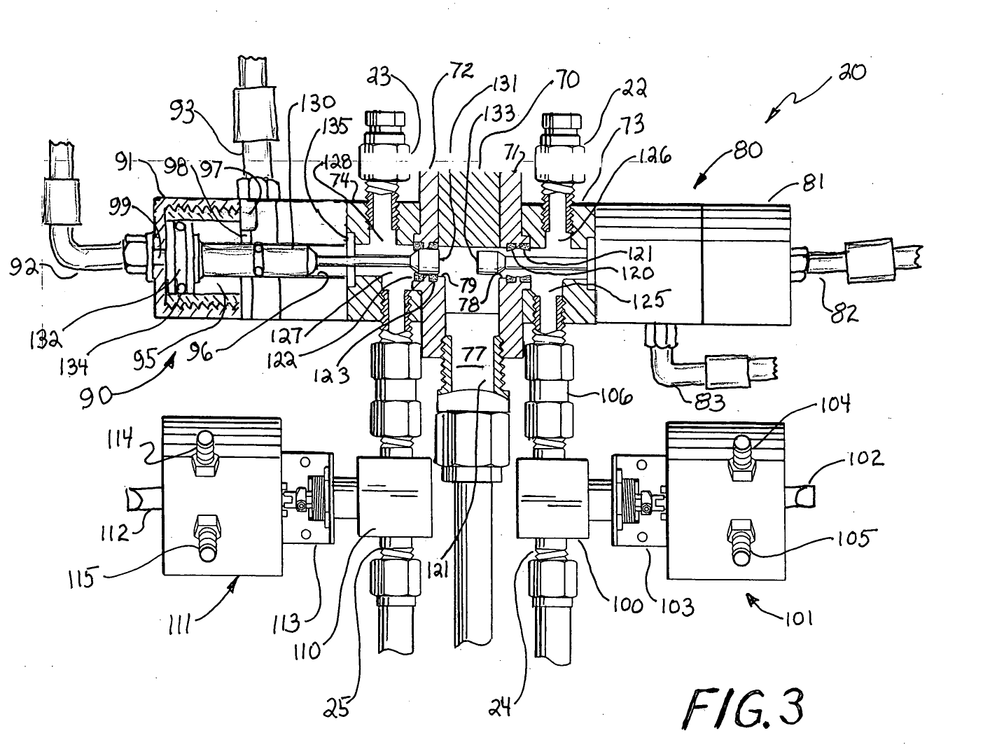

More specifically, painting system 10 shown in FIG. 1 utilizes a central supply area generally referenced by numeral 11 having a pair of separate spray booths 12 and 13 on either side thereof. Central supply area 11 supports a paint delivery assembly 14 which is typically a pump having a plurality of paint pump stages such as stages 18 and 19 coupled to a paint output line 15. It will be understood by those skilled in the art that a number of paint pumps may be utilized for pump stages 18 and 19 without departing from the spirit and scope of the present invention. Also, paint pumps 18 and 19 may be simple pressure pots or other such devices. For example, pump stages 18 and 19 may be fabricated utilizing double acting rod pump apparatus such as that set forth in U.S. Pat. No. 6,398,514 issued to Smith, et al. The essential function of paint pump assembly 14 is to provide a source of paint or other material which is under sufficient pressure to be utilized within the system. Thus, paint pump assembly 14 provides a source of material under pressure which is coupled by a paint output line 15 to a line splitter assembly 20. Line splitter assembly 20 is described below in FIGS. 2 and 3 in greater detail. However, suffice to note here that line splitter assembly 20 includes a paint input 21, a pair of paint outputs 22 and 23 which are controlled by the valve apparatus described below within line splitter assembly 20. For explanation here, it is sufficient to note that the paint supply coupled to line splitter assembly 20 via paint line 15 may be applied to outputs 22 and 23 concurrently, individually or be completely turned off as desired.

Central supply area 11 also includes a solvent supply 16 which provides a source of liquid solvent under pressure to a solvent output line 17. Output line 17 is coupled to solvent lines 30, 31, 32, 25, 35 and 36.

Spray booth 12 supports a pair of spray guns 60 and 61 which are fabricated in accordance with conventional fabrication techniques and which are utilized by spray gun operators or “painters” to apply paint material within spray booth 12. Spray booth 12 further includes a line splitter assembly 40 which is substantially identical to line splitter assembly 20 and thus is equally well described below in FIGS. 2 and 3. Suffice it to note here that line splitter assembly 40 includes a paint input 41 which is coupled to output 22 of line splitter assembly 20 by a paint line 34. Line splitter assembly 40 further includes a pair of solvent inputs 44 and 45 which are coupled to coupled to solvent lines 30 and 35 respectively. To accommodate the appropriate control of pressure required by spray guns 60 and 61, a pair of pressure regulators 46 and 47 are coupled to paint outputs 42 and 43 respectively. Conventional paint lines 64 and 65 are operatively coupled between regulators 46 and 47 and spray guns 60 and 61 respectively.

Spray booth 13 includes a pair of spray guns 62 and 63 operatively coupled to paint lines 66 and 67 respectively. Spray booth 13 further includes a line splitter assembly generally referenced by numeral 50 which in constructed in accordance with the present invention and which is substantially identical to line splitter assembly 20. Thus, line splitter assembly 50 includes a paint input 51 coupled to paint output 23 of line splitter assembly 20 by a paint line 33 together with paint outputs 52 and 53. A pair of pressure regulators 56 and 57 are coupled to paint outputs 52 and 53 respectively. A pair of paint lines 66 and 67 operatively couple spray guns 62 and 63 respectively to pressure regulators 56 and 57. Line splitter assembly 50 also includes a pair of solvent inputs 54 and 55 which are coupled to solvent lines 36 and 31 respectively.

It will be apparent to those skilled in the art that solvent supply 16 may be fabricated using conventional air pressure driven apparatus or virtually any pumping mechanism capable of providing solvents under sufficient pressure to function within the present invention system. Once again, the essential function of solvent supply 16 is to provide a source of solvent under pressure to be carried by the various solvent lines to line splitter assemblies 20, 40 and 50.

In the preferred fabrication of the present invention, line splitter assemblies 20, 40 and 50 are operated using air actuated valve apparatus. Thus, in FIGS. 2 and 3 and the descriptions which accompany them below, various valve apparatus are shown which are actuated utilizing pressurized air in accordance with conventional fabrication techniques. It will be apparent those skilled in the art, however, that other actuation apparatus may be utilized without departing from the spirit and scope of the invention. For example, electrically actuated valve apparatus may be utilized without departing from the spirit and scope of the present invention. Additionally, it will be understood in FIG. 1 that to avoid unduly cluttering the figure, the various control air connections utilized in operating the system shown in FIG. 1 have been omitted.

In operation with painting system 10 operative at full capacity, line splitter 20 is configured to flow paint to paint outputs 22 and 23. The paint is then transferred by paint lines 33 and 34 to paint input 51 of line splitter assembly 50 and paint input 41 of line splitter assembly 40. Correspondingly, when operating at full capacity, line splitter assembly 40 couples paint to paint outputs 42 and 43 while line splitter assembly 50 couples paint to outputs 52 and 53. In this manner, pressurized paint is supplied to spray guns 60 and 61 within spray booth 12 and to spray guns 62 and 63 within spray booth 13. During these full capacity operations, line splitter assembly 20 maintains a closed condition for solvent flow at solvent inputs 24 and 25. Similarly, line splitter assembly 40 maintains a closed condition at inputs 44 and 45 while line splitter assembly 50 maintains a closed condition at solvent inputs 54 and 55. Thus, full capacity operation is characterized by paint flow to each spray gun within the system and is further characterized by an absence of solvent flow beyond line splitter assemblies 20, 40 and 50.

In the event a need arise to shut down the operation of a single spray gun such as spray gun 63 and take it off-line for an extended time, the advantages of the present invention system become immediately apparent. It will be recalled that in interrupting the operation of spray gun 63 for an extended period of time, the characteristics of the paint being sprayed required that the unused spray gun and all of its associated lines and components must be completely cleaned and flushed with an appropriate solvent material. This need to immediately clean an off-line spray gun may be accommodated without interrupting the operation of the remaining spray guns within the system. Thus, in the example of taking spray gun 63 off-line and maintaining the continued uninterrupted operation of spray guns 60, 61 and 62, line splitters assemblies 20 and 40 remain configured in the manner shown while line splitter assembly 50 operates to isolate and clean spray gun 63, paint line 67, pressure regulator 57 and all associated portions of the system which supply and transfer paint to spray gun 63. Once again, the operation of the present invention line splitters assemblies is described below in FIGS. 2 and 3 in greater detail. Suffice it to note here that line splitter assembly 50 operates to terminate the flow of paint from paint line 33 to paint output 53 while simultaneously maintaining the continued flow of paint to paint output 52. The continued supply of paint to paint output 52 maintains the operation of spray gun 62. Concurrently, line splitter assembly 50 maintains the closure of solvent input line 54 while opening solvent line 55 allowing solvent to flow from solvent line 31 through a portion of line splitter assembly 50 to output 53. Solvent further flows through regulator 57, paint line 67 and spray gun 63. The flow of solvent through line splitter assembly 50, pressure regulator 57, paint line 67 and spray gun 63 is continued to provide complete cleaning while maintaining the operative on-line configuration for spray guns 60, 61 and 62. For purpose of illustration, FIG. 1 illustrates this operating condition using solid dark lines for indicating paint flow while utilizing white lines for indicating solvent flow. Once spray gun 63 together with paint line 67 and regulator 57 have been thoroughly cleaned, solvent input 55 is again closed by the operation of line splitter assembly 50 and spray gun 63 is now off-line while spray guns 60, 61, and 62 continue their uninterrupted operation.

Thus, in accordance with an important aspect of the present invention, the above shutdown of spray gun 63 and the cleaning of its associated system components has been obtained without interrupting the operation of the on-line spray guns within the system. Thus, the present invention line splitter assembly is operative within the system to selectively terminate paint flow to one or more spray guns and to initiate a flow of solvent therethrough without interrupting the paint flow to the remaining spray gun or guns.

In accordance with the present invention, it will be apparent that line splitter assembly 50 may also be operated to shutdown spray gun 62 while maintaining spray gun 63 in operation utilizing the reverse of the above-described procedure. It will be further apparent that line splitter assembly 50 may be operative to shutdown spray guns 62 and 63 and initiate cleaning thereof without interrupting the operation of spray guns 60 and 61. It will be equally apparent that line splitter assembly 40 may be utilized to initiate shutdown and cleaning of spray guns 60 or 61 in the above-described manner. Additionally, the operations of line splitters 20, 40 and 50 may be configured to terminate the operation of an entire spray booth. For example, in the event it is desired to shutdown the operation of spray booth 12 while maintaining the operation of spray booth 13, line splitter assembly 40 remains configured to supply paint from paint input 41 to outputs 42 and 43 while line splitter assembly 20 is configured to terminate paint flow from paint input 21 to paint output 22. Concurrently, line splitter assembly 20 opens the solvent closure at solvent input 24 allowing solvent to flow through line splitter 20 through paint output 22 and paint line 34. This flow of solvent enters paint input 41 and flows through line splitter assembly 40 and outwardly through paint outputs 42 and 43. The flow of solvent continues through regulators 46 and 47 as well as paint lines 64 and 65 and ultimately exits through spray guns 60 and 61. In this manner, the present invention system isolates spray booth 12 and initiates a complete cleaning of its apparatus while maintaining spray booth 13 and its spray guns in continued uninterrupted line operation.

FIG. 2 sets forth a more detailed view of line splitter assembly 20. As mentioned above, line splitter 20 is illustrative of the present invention line splitter assemblies and thus the descriptions set forth in FIGS. 2 and 3 will be understood to apply equally well and be equally descriptive of line splitter assemblies 40 and 50 (seen in FIG. 1). It will also be noted by examination of FIG. 2 that the above-mentioned air control line inputs to line splitter assembly 20 are shown in FIG. 2. These inputs will be understood to be utilized by an appropriate pneumatic control apparatus for operating the various valve portions of line splitter assembly 20 described below.

More specifically, line splitter assembly 20 includes a manifold 70 having a paint input 21. Line splitter 20 further includes a line splitter valve 80 which is coupled to manifold 70 by a seal gland 71. Line splitter assembly 20 further includes a line splitter valve 90 which is coupled to the opposite side of manifold 70 by a seal gland 72. Line splitter valve 80 includes a material block 73 coupled to gland 71. Material block 73 further supports a paint output coupling 22 and a solvent input 106. Line splitter valve 80 further includes a valve body 84 supporting an oil cup 75 and further supporting an air cap 81. Air cap 81 in turn supports an air line coupler 82 while valve body 84 supports an air line coupler 83.

Line splitter valve 90 includes a material block 74 having a paint output coupling 23 and a solvent input coupling 116 supported thereon. Material block 74 is joined to seal gland 72. A valve body 94 is joined to material block 74 and further supports an air line coupler 93 and an oil cup 76. An air cap 91 is received upon valve body 94 and further supports an air line coupler 92.

Line splitter assembly 20 further includes a solvent block valve 100 having a solvent input 124 and a solvent output 106. A pneumatic actuator 101 is operatively coupled to solvent block valve 100 by a coupler 103. Pneumatic actuator 101 includes an operative shaft 102 which is operatively coupled to coupler 103. Actuator 101 includes a pair of air line couplers 104 and 105. A bracket 107 is secured to solvent block valve 100 and actuator 101 to provide mechanical support.

A solvent block valve 110 includes an input 25 and a solvent output 116. Output 116 is coupled to material block 74. An actuator 111 includes a shaft 112 which is operatively coupled to solvent block valve 110 by a coupler 113. Actuator 111 further includes a pair of air line couplers 114 and 115. A bracket 117 is joined to solvent block valve 110 and actuator 111 to provide mechanical support.

In operation, solvent inputs 24 and 25 are coupled to a supply of solvent under pressure. Similarly, paint input 21 is coupled to a supply of paint under pressure while paint outputs 22 and 23 are coupled to paint lines which comprise supply lines for the host painting system (seen in FIG. 1). Additionally, a plurality of pneumatic system control lines are operatively coupled to air line couplers 82, 83, 92, 93, 104, 105, 114 and 115. Actuator 101, coupler 103 and solvent block valve 100 may be provided utilizing any of a variety of standard pneumatically actuated cutoff valves available in the marketplace. For example, a conventional two-way ball type pneumatic cutoff valve such as that which is manufactured and sold by Swagelok, Incorporated or its equivalent may be utilized to fulfill the operation of solvent block valve 100, coupler 103 and actuator 101. The combination of actuator 101, coupler 103 and solvent block valve 100 is to control the flow of solvent through solvent block 100 from input 24 to input 106.

Similarly, the combination of actuator 111, coupler 113 and solvent block valve 110 may be provided utilizing a standard pneumatically operated cutoff valve such as the above-described commercially available valve. In further similarity, the function of the combination of actuator 111, coupler 113 and solvent block 110 is to provide control of solvent flow from input 25 to output 116 of solvent block valve 110. Thus, operation of actuators 101 and 111 allows selective flow of solvent into material block 73 and/or 74 as desired.

Manifold 70 together with line splitter valves 80 are 90 are operative to selectively couple paint flow from paint input 21 to either or both of paint outputs 22 and 23. The operation of line splitter valves 80 and 90 is set forth below in greater detail, suffice it to note here that actuation of line splitter valve 80 allows paint flow from input 21 to output 22 while operation of line splitter valve 90 allows paint flow from input 21 to output 23. Simultaneous actuation of line splitter valves 80 and 90 allows either concurrent paint flow from input 21 to outputs 22 and 23 or simultaneous closure and termination of paint flow. The operations of line splitter valves 80 and 90 is described below in greater detail and is achieved by control air applied selectively to air line couplers 82, 83, 92, and 93.

FIG. 3 sets forth a partially sectioned view of line splitter assembly 20 showing the operation of line splitter valves 80 and 90. FIG. 3 sets forth a section view of line splitter valve 90 in a closed configuration in which paint does not flow to output 23. In addition, FIG. 3 shows a partially sectioned view of line splitter valve in an open configuration which allows paint flow to paint output 22.

More specifically, line splitter assembly 20 includes a manifold 70 having a paint input 21. Line splitter 20 further includes a line splitter valve 80 which is coupled to manifold 70 by a seal gland 71. Line splitter assembly 20 further includes a line splitter valve 90 which is coupled to the opposite side of manifold 70 by a seal gland 72. Line splitter valve 80 includes a material block 73 coupled to gland 71. Material block 73 further supports a paint output coupling 22 and a solvent input 106. Line splitter valve 80 further includes a valve body 84 supporting an oil cup 75 and further supporting an air cap 81. Air cap 81 in turn supports an air line coupler 82 while valve body 84 supports an air line coupler 83.

Line splitter valve 90 includes a material block 74 having a paint output coupling 23 and a solvent input coupling 116 supported thereon. Material block 74 is joined to seal gland 72. A valve body 94 is joined to material block 74 and further supports an air line coupler 93 and an oil cup 76. An air cap 91 is received upon valve body 94 and further supports an air line coupler 92.

Line splitter assembly 20 further includes a solvent block valve 100 having a solvent input 124 and a solvent output 106. A pneumatic actuator 101 is operatively coupled to solvent block valve 100 by a coupler 103. Pneumatic actuator 101 includes an operative shaft 102 which is operatively coupled to coupler 103. Actuator 101 includes a pair of air line couplers 104 and 105. A bracket 107 is secured to solvent block valve 100 and actuator 101 to provide mechanical support.

A solvent block valve 110 includes an input 25 and a solvent output 116. Output 116 is coupled to material block 74. An actuator 111 includes a shaft 112 which is operatively coupled to solvent block valve 110 by a coupler 113. Actuator 111 further includes a pair of air line couplers 114 and 115. A bracket 117 is joined to solvent block valve 110 and actuator 111 to provide mechanical support.

Manifold 70 includes an input passage 77 which is coupled to paint input 21 together with a pair of output passages 78 and 79 extending in opposite directions. Seal gland 71 continues output passage 78 and supports a pair of resilient seals 120 and 121. Similarly, seal gland 72 continues output passage 79 and supports a pair of resilient seals 122 and 123. Material block 73 is joined to seal gland 71 and defines an input passage 125 coupled to insolvent input 106 and an output passage 126 coupled to paint output 22. Material block 73 further defines a transverse passage within which a spool 133 is movably supported in the manner described below.

Material block 74 defines an input passage 127 coupled to solvent input 116 and an output passage 128 coupled to paint output 23. A transverse passage extends through material block 74 and receives and supports a resilient seal 135. Valve body 94 is joined to material block 74 and defines an internal bore 96. Valve body 94 further defines an air passage 97 which is operatively coupled to air line coupler 93. A threaded extension of valve body 94 defines an internal air chamber 95 together with a port 98 coupling air chamber 95 to air passage 97. Air cap 91 is threadably secured upon the extension of valve body 94 and defines a port 99 which communicates with air chamber 95 and which is coupled to air line coupler 92. A spool piston assembly 130 defines an elongated cylindrical member received within bore 96 and supporting a piston 132 within air chamber 95. Piston 132 further supports an o-ring seal 134. The interior end of spool piston assembly 130 supports an inwardly extending spool 131. Spool 131 extends through seal 135 and terminates in a spool end within passage 79.

In the position shown in FIG. 3, spool piston assembly 130 occupies the position within line splitter valve 90 corresponding to closure of paint coupling through manifold 70 to paint output 23. Thus, in this position which in FIG. 3 corresponds to the left most travel of spool piston assembly 130, spool 131 is received within resilient seals 122 and 123. In this position, the sealing engagement between seals 122 and 123 and the enlarged end of spool 131 provides complete closure of passage 79. Thus, paint entering manifold 70 through input passage 77 is prevented from flowing into the interior of material block 74. Conversely, the position shown for spool 133 corresponds to the open configuration for material block 73. Comparison of spools 131 and 133 shows that the open configuration for spool 133 is achieved by moving spool 133 inwardly to a position within manifold 7 which is separated from resilient seals 120 and 121. In the open configuration shown for material block 73, paint is able to flow from input passage 77 of manifold 70 outwardly through passage 78 and beyond. The paint flow continues outwardly through passage 126 to paint output 122.

Thus, FIG. 3 illustrates the configuration of line splitter assembly 20 in which paint is flowing outwardly from the paint output 22 but is not flowing outwardly from paint output 23.

The position of spool piston assembly 130 within valve body 94 is controlled by the application of air pressure to coupler 93 or coupler 92. In the closed position shown, spool piston assembly 130 has been moved by air pressure applied to coupler 93 which transfers through port 98 into air chamber 95. The air pressure within air chamber 95 forces piston 132 toward port 99 moving spool 131 into sealing engagement with seals 122 and 123. Conversely, line splitter valve 90 is moved to an open configuration such as that shown for valve 80 by applying air pressure to coupler 92. This air pressure is transferred through port 99 and is applied to piston 132 forcing piston 132 and spool piston assembly 130 to move in the right in the diagram shown. This movement of spool piston assembly 130 moves the enlarged end of spool 131 into manifold 70 away from resilient seals 122 and 123 to the open position shown for spool 133.

In the configuration shown in FIG. 3, actuator 101 is operative to maintain solvent block valve 100 in its closed position. Thus, solvent does not flow from solvent input 24 to coupler 106. Conversely, with line splitter valve 90 in its closed configuration, material block 74 and paint output 23 are isolated from the remainder of the system within which line splitter assembly 20 is operating. Under these conditions, actuator 111 may be operated to open solvent block valve 110 and permit the flow of solvent through input 25 and coupler 116 into passage 127 of material block 74. Continuing, solvent then flows outwardly through passage 128 to paint output 123. With temporary return to FIG. 1, this configuration corresponds to the flow of solvent shown in FIG. 1 for flushing spray gun 63. Returning to FIG. 3 it will be noted that as solvent flows through input coupler 116, passage 127 and passage 128, seal 135 contains the solvent within material block 74 while the sealing engagement of resilient seals 122 and 123 against the enlarged end of spool 131 prevents solvent flow into manifold 70. As a result, the entire interior of material block 74 is cleaned by the flow of solvent therethrough and outwardly from paint output 23. As described above, the solvent flow passes through the remaining components which are coupled to paint output 23 to continue cleaning activity.

In accordance with an important aspect of the present invention, FIG. 3 shows the continued painting operation for apparatus coupled to output 22 while a cleaning cycle is initiated to apparatus coupled to paint output 23 without disturbing the remaining painting operations. It should also be noted that the flow of solvent through material block 74 completely exposes and cleanses all portions thereof which have been previously exposed to paint. As a result, the cleaning operation eliminates any residual or dead spot accumulations of paint.

What has been shown is a novel multiple valve fluid manifold and line splitter assembly which facilitate selective isolation and cleaning of a portion of a multiple spray gun, multiple spray booth facility without interrupting the operation of the remainder of the system. The complete isolation of the to-be-cleaned portion of the system is achieved by a manifold and a material block combination which ensures the complete isolation of selected paint circuits which are being taken off-line and the complete flushing thereof without interruption of on-line operation of the remainder of the system. As a result, one line circuit of a painting system may be taken off-line and completely flushed without unflushed residuals remaining in dead spots, cavities or pockets within the system.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A multiple valve fluid manifold and line splitter comprising:
a manifold having an input passage, a manifold chamber and a pair of manifold output passages;
a first material block having a first material input passage coupled to one of said manifold output passages, a first solvent input passage, a first output passage and a first material valve interposed between said one of said manifold output passages and said first material input passage;
a second material block having a second material input passage coupled to the remaining one of said manifold output passages, a second solvent input passage, a second output passage and a second material valve interposed between said remaining one of said manifold output passages and said second material input passage; and
first and second solvent block valves coupled to said first and second solvent input passages respectively,
said first and second material valves each defining an open condition allowing fluid flow from said manifold chamber to said first and second output passages respectively and a closed condition preventing said fluid flow and said first and second solvent block valves each defining an open condition allowing solvent flow into said first and second solvent input passages and a closed position preventing said solvent flow.

2. The multiple valve fluid manifold and line splitter set forth in claim 1 wherein said first and second material valves include first and second spool valves and first and second resilient seals within said first and second material input passages.

3. The multiple valve fluid manifold and line splitter set forth in claim 2 wherein said first and second spool valves are pneumatically actuated.

4. The multiple valve fluid manifold and line splitter set forth in claim 3 wherein said first and second solvent block valves are pneumatically actuated.

5. A multiple valve fluid manifold and line splitter comprising:
a manifold having a manifold material input passage, first and second manifold material output passages and a manifold chamber in communication therewith;
a first line splitter valve having a first material input coupled to said first manifold material output passage, a first solvent input, a first material output and first valve means for permitting and preventing fluid flow from said first material input to said first material output;
a second line splitter valve having a second material input coupled to said second manifold material output passage, a second solvent input, a second material output and second valve means for permitting and preventing fluid flow from said second material input to said second material output; and
solvent valve means coupled to said first and second solvent inputs for flowing solvent into either or both of said first and second solvent inputs and preventing solvent flow into either or both of said first and second solvent inputs.

6. The multiple valve fluid manifold and line splitter set forth in claim 5 wherein said solvent valve means includes:
a first solvent block valve, defining an open condition and a closed condition, coupled to said first solvent input; and
a second solvent block valve, defining an open condition and a closed condition, coupled to said second solvent input.

7. The multiple valve fluid manifold and line splitter set forth in claim 6 wherein said first and second line splitter valves are spool valves.

8. The multiple valve fluid manifold and line splitter set forth in claim 7 wherein said first and second solvent block valves and said first and second line splitter valves are pneumatically operated.

9. A multiple valve fluid manifold and line splitter comprising:
a first manifold having a first manifold chamber, a first material input coupled to said first manifold chamber and first and second material outputs coupled to said first manifold chamber;
a first line splitter valve, coupled to said first material output, defining an open condition flowing material from said first material output and a closed condition preventing material flow from said first material output, and having a first solvent input;
a second line splitter valve, coupled to said second material output, defining an open condition flowing material from said second material output and a closed condition preventing material flow from said second material output, and having a second solvent input; and
first solvent valve means coupled to said first and second solvent inputs for flushing solvent through said first and second line splitter valves, together or individually.

10. The multiple valve fluid manifold and line splitter set forth in claim 9 further including:
a second manifold having a second manifold chamber, a second material input coupled to said second manifold chamber and third and fourth material outputs coupled to said second manifold chamber;
a third line splitter valve, coupled to said third material output, defining an open condition flowing material from said third material output and a closed condition preventing material flow from said third material output, and having a third solvent input;
a fourth line splitter valve, coupled to said fourth material output, defining an open condition flowing material from said fourth material output and a closed condition preventing material flow from said fourth material output, and having a fourth solvent input; and
second solvent valve means coupled to said third and fourth solvent inputs for flushing solvent through said third and fourth line splitter valves, together or individually,
said first material input being coupled to a pressurized material supply, said first material output being coupled to said second material input and said first and second solvent valve means being coupled to a pressurized solvent supply.

11. The multiple valve fluid manifold and line splitter set forth in claim 10 further including:
a third manifold having a third manifold chamber, a third material input coupled to said third manifold chamber and fifth and sixth material outputs coupled to said third manifold chamber;
a fifth line splitter valve, coupled to said fifth material output, defining an open condition flowing material from said fifth material output and a closed condition preventing material flow from said fifth material output, and having a fifth solvent input;
a sixth line splitter valve, coupled to said sixth material output, defining an open condition flowing material from said sixth material output and a closed condition preventing material flow from said sixth material output, and having a sixth solvent input; and
sixth solvent valve means coupled to said fifth and sixth solvent inputs for flushing solvent through said fifth and sixth line splitter valves, together or individually,
said second material output being coupled to said third material input and said third solvent valve means being coupled to a pressurized solvent supply.
